(19) United States
(12) Patent Application Publication
(10) Pub. No.: US 2003/0083980 A1
(43) Pub. Date: May 1, 2003

(54) Greenhouse effect gas emission index monitoring and converting system

(76) Inventor: Tsukasa Satake, Kyoto (JP)

Correspondence Address: PRICE AND GESS, Ste. 250, 2100 S.E. Main St., Irvine, CA, 92614, US

(21) Appl. No.: 10/231,932

(22) Filed: Aug. 29, 2002

(30) Foreign Application Priority Data
Aug. 31, 2001 (JP) 2001-264815
Sep. 19, 2001 (JP) 2001-284458

(51) Int. Cl. G06F 17/60

(52) U.S. Cl. 705/37

(57) ABSTRACT

A system for providing an exchange market for trading assigned quotas of permissible pollutants and monitoring the pollutants through a global computer network is provided. A standardized source for providing formulas or algorithm data to establish a relationship between pollutant emissions and an assigned quota to enable a usage rate relative to a predetermined index value can be provided by a regulatory body connected to the global computer network. Individual users can provide monitoring units for measuring the actual pollutant emissions and outputting a corresponding signal. An operation control unit can store the algorithm data or formulas and the pollutant emission signal and calculate a real time usage rate. This usage rate can be monitored to determine compliance and provide a real time usage rate over a number of different users forming a particular district or division. A trade market unit is established for listing real time surplus usage rates relative to a predetermined index rate that is common to all users. Users that are below their assigned quota can be advised to purchase or trade with users who are above their assigned quotas. The individual users can be connected so that the trade market unit can determine a matching of a listed surplus rate with the real time usage rate when the user rate is over the assigned quota, or a listed shortage rate with the real time usage rate when the user is under the assigned quota.

### BACKGROUND OF THE INVENTION

1. Field of the Invention

The present invention relates to a system for monitoring pollutant emissions such as a greenhouse effect gas emission monitoring and index converting system for regulating the emissions rights of a user of greenhouse effect gases on the basis of a single standard emission index in order to prevent global warming, and an exchange market system for trading emissions rights between users on the basis of the single emission index.

2. Description of Related Art

It is feared that global warming is being promoted by factory emission gases such as CO₂, CH₄, N₂O, HFC, PFC, and SF₆ which are frequently designated as greenhouse effect gases. Currently, there is an international attempt to provide a general framework of emission rights of greenhouse effect gases among the nations in the world. At the present, however, specific systems or methods for exercising the emission rights of greenhouse effect gas appropriately by each nation, and means for monitoring and controlling the emission of such greenhouse effect gases, and assigning related penalties are in the process of discussion and negotiation.

Presently, any geographic district or commercial enterprise does not have a set of procedures for calculating an emission index of greenhouse effect gases which is effective for determining an emission framework of greenhouse effect gases, and regulations of agreed emission amounts are not currently determined despite the seriousness of the effects of increasing the emission of greenhouse effect gases on the global environment. Accordingly, the districts and enterprises are currently debating to establish certain regulating procedures for determining an emission framework of greenhouse effect gases, and various calculation methods are being proposed for asserting an erission index of greenhouse effect gases for this purpose.

Generally, as a calculation method of an emission index of greenhouse effect gases, the amount of carbon is converted on the basis of accumulated information from internationally recognized research institutes and industrial societies, and in the semiconductor industry, for example, the following formula (1) has been proposed and employed as the Million Metric Ton Carbon Equivalent (MMTCE).

$$MMTCE = 12 / 44 {\sum }_{i} \{ Pi \times 0.9 \times ( 1 - C ) \times ( 1 - A \times F ) \times GWPi \} \qquad ( 1 )$$

where pi is purchase amount, C is consumption rate in the process, A is an abatement efficiency, F is fraction of gas volume in abatement equipment, and GWPi is 100-year value of global warming potential for gas.

The above-mentioned purchase amount Pi is the amount of greenhouse effect gases purchased by each enterprise, the abatement efficiency A shows the efficiency guaranteed by the manufacturer of the abatement equipment attached to the process, and GWPi is determined by an Intergovernmental Panel on Climate Change (IPCC) as a proposed environmental management office.

By suppressing the emission index of the greenhouse effect gases calculated by using such a conversion formula (1), for example, within the specified range assigned for each enterprise, it is considered possible to define limits on total user emission of greenhouse effect gases of each enterprise. That is, by determining a common reference of emission index of greenhouse effect gases, each enterprise can judge if its own total emission is within the emission framework or not, and, in the future, an enterprise short of the emissions rights may purchase from an enterprise having an enough emissions rights.

However, the consumption rate C by the above-mentioned process or the decomposition factor F of the abatement equipment may vary significantly depending on the situation of a particular process, but the consumption rate C is always constant in the above-mentioned formula (1). Similarly, the decline of decomposition factor F of the abatement equipment is calculated to be a constant abatement efficiency A, but actually fluctuations are inevitable in practice. Accordingly, if the input values are correct, the emission index of the greenhouse effect gases determined according to the above-mentioned formula (1) can often be different from the actual situation of a particular user.

In addition, it is not always fair in this method of calculation of determining plant emission gas by a self-declaration of a manager of the enterprise. For example, if a wrong value is entered from the greenhouse effect gas purchase by the enterprise, or the efficiency of the abatement equipment is evaluated higher than the actual value, the calculation of the above-mentioned formula (1) may be significantly different from the actual emission amount. In the above-mentioned formula (1), the greenhouse effect gases as the byproduct of the process is not considered in the calculation and a larger amount of greenhouse effect gases may be actually discharged as a byproduct.

Accordingly, for calculation of an emission index of the above-mentioned greenhouse effect gases, various conversion formulas (Tier 1, Tier 2A, Tier 2B, Tier 2C, etc.) are being proposed by IPCC in order to calculate fair values. In this case, however, it is difficult to judge which conversion formula should be used to determine an emission formula as a common reference, e.g., to permit a trading of emissions rights between users, and it may be hard to agree to an actual trade of an emission amount.

Constants used in conversion formulas determined by IPCC (for example, consumption rate C in process, abatement efficiency A by abatement equipment, decomposition factor F of abatement equipment, and global warming index (GWPi), and conversion formulas are not fixed but should be changed and updated along with progress in the accuracy of instruments and the efficiency of a manufacturing line. Accordingly, every time the conversion formula or constant is reviewed, the emission index of greenhouse effect gases must be calculated.

### SUMMARY OF THE INVENTION

The present invention is devised in the light of such background, and it is hence an object thereof to present a greenhouse effect gas emission index converting system for converting an emission index of greenhouse effect gases on the basis of input information by using a specified conversion formula, and calculating the emission index of greenhouse effect gases more accurately and fairly in order to enable a trading of emissions rights of greenhouse effect gases at high reliability.

The greenhouse effect gas emission index converting system of the present invention includes a data input unit for entering various data for calculating the index emission of greenhouse effect gases, an information input unit for incorporating the conversion information for calculating the emission index of the greenhouse effect gases by using various data, an operation processing unit for calculating the emission index of greenhouse effect gases by calculating various data according to the conversion information, and an information output unit for issuing the calculated emission index.

In the above-mentioned greenhouse effect gas emission index converting system, since the conversion information for converting into the emission index of greenhouse effect gases is incorporated through the information input unit, the conversion information can be always updated to the latest value, and the method of converting into the emission index of greenhouse effect gases can be standardized. Therefore, on the basis of the emission index of greenhouse effect gas calculated according to a unified converting method, every nation, every district, and every enterprise can determine the emission amount of greenhouse effect gases and/or trade the emissions rights between users.

Various data to be entered through the data input unit include, for example, the number of cylinders filled with greenhouse effect gases, residual gas rate in returned cylinders, gas consumption rate, type of process, decomposition factor of abatement equipment, and other data, which can be entered through a keyboard.

If a part of the above-mentioned various data includes measured concentration and a flow rate of greenhouse effect gases, and when calculating the emission index by integration of their multiplied products, it is possible to use analyzers and flow meters capable of measuring the concentration and flow rate of gas emitted through a flue, these measured values may be determined as various data from the integration of the emission amount of the greenhouse effect gases by actually measuring the emission index of the greenhouse effect gases.

In this case, since the emission amount and emission rate of greenhouse effect gases can be measured in real time and verified, the values can be instantly used in trading rights. Since the emission index of greenhouse effect gases is also determined from the measured values by a gas analyzer and flow meter, the actual emission amount of the greenhouse effect gases can be determined more accurately. Fluctuations of the emission index of greenhouse effect gases caused by a decline of efficiency of abatement equipment, process abnormality, or appearance of byproducts, can be correctly measured, the calculated emission index will not be different from the actual value.

In particular, since the emission index of greenhouse effect gases does not vary depending on the values entered by the operators, the reliability is assured, and a fair trade can be made between users. Therefore, in the future, the emission index of greenhouse effect gases may be expressed at MMTCE, and an emission tax can be charged.

When at least one of incorporation of various data in the above-mentioned data input unit, incorporation of conversion information in the above-mentioned information input unit, or output of an emission index in the above-mentioned information output unit is executed through an active global computer network, the conversion information can be updated easily and automatically, and the conversion information may be unified more easily to define the emission amount of greenhouse effect gases, and the emissions rights can be traded on such a global computer network.

When the above-mentioned conversion information involves a conversion formula for calculating the emission index of greenhouse effect gases determined by the monitoring organization for organizing the emission amount of greenhouse effect gases and/or the constants used in such conversion formula, contents of calculation using various data in the operation processing unit can be easily changed, and when the conversion formula for calculating the emission index of greenhouse effect gases or the constants used in the conversion formula are revised by the IPCC or the like, it is still possible to calculate by incorporating the revised conversion formula.

The contents of the above-mentioned calculation may be offered in various methods, and may be supplied, for example, by a calculation program that can be executed by the above-mentioned operation processing unit compiled on the basis of the conversion formula disclosed by the IPCC or the like. Further, the conversion formula for converting the various input data into the emission index of greenhouse effect gases may be expressed by conforming to a specified format such as a matrix calculation, and the contents of the calculation may be supplied in a format of matrices.

When each greenhouse effect gas emission index converting system stores plural calculation programs supplied as conversion formulas, the conversion formulas may be properly changed over and used depending on the situation, so that the emissions rights may be traded smoothly.

When the above-mentioned conversion information has a conversion rate for calculating the emission expense of greenhouse effect gases by multiplying with the emission index of greenhouse effect gas, and the above-mentioned operation processing unit has a market reference function of entering the above-mentioned conversion rate, exchange rate and other trade information from the trade market of greenhouse effect gases through the above-mentioned information input unit, if the conversion rate varies due to trade market fluctuations, due reactions may be made in real time.

Further, when the above-mentioned operation processing unit has a market disclosure function of outputting the trade amount by multiplying the trade information such as conversion rate and exchange rate with the emission index of the above-mentioned greenhouse effect gases to the trade market of greenhouse effect gases through the above-mentioned information output unit, trade with the market can be automated, and the emissions rights of greenhouse effect gases can be traded easily.

In summary, a system is provided for enabling an exchange market for trading assigned quotas of permissible pollutants between users. A standardized source for providing algorithm data to establish a relationship between pollutant emissions and an assigned quota to enable a universal usage rate relative to a predetermined index value is provided. The standardized source can be from a recognized international agency and can be updated periodically or automatically to ensure standardization. The user can install a monitoring unit for measuring the actual pollutant emissions of the user and create corresponding signals through the use of known instrumentation and anticipated instrumentation that is going to be developed in the future, to provide output values such as gas flows, gas analysis, etc. Verification of the monitoring unit may also be accomplished on an on-line basis by interconnection with a global computer network. A control unit, such as a computer-based system, can store the algorithm data, or standardized equations, and can receive and store the emission signals from the monitoring unit and can calculate a real time usage rate. The control unit can also post the actual usage rate with a trade market unit that is capable of listing real time surplus usage rates relative to the predetermined index rate, and thereby permit users of the trade market unit to sell, purchase, or barter rights between the assigned quotas and the actual users that are verified. As can be appreciate, such a system also permits monitoring pollutants relative to the standardized quota system to thereby provide a verification of the actual pollutant rates relative to the assigned quota of any particular user.

### BRIEF DESCRIPTION OF THE DRAWINGS

FIG. 1 is a schematic diagram showing a configuration of a greenhouse effect gases emission index converting system of the present invention;

FIG. 2 is a schematic diagram showing a modified example of the greenhouse effect gases emission index converting system of FIG. 1;

FIG. 3 is a schematic diagram showing a different example of the greenhouse effect gases emission index converting system; and

FIG. 4 is a schematic diagram showing a modified example of the greenhouse effect gas emission index converting system of FIG. 3.

### DETAILED DESCRIPTION OF THE PREFERRED EMBODIMENTS

The following description is provided to enable any person skilled in the art to make and use the invention and sets forth the best modes contemplated by the inventor of carrying out his invention.

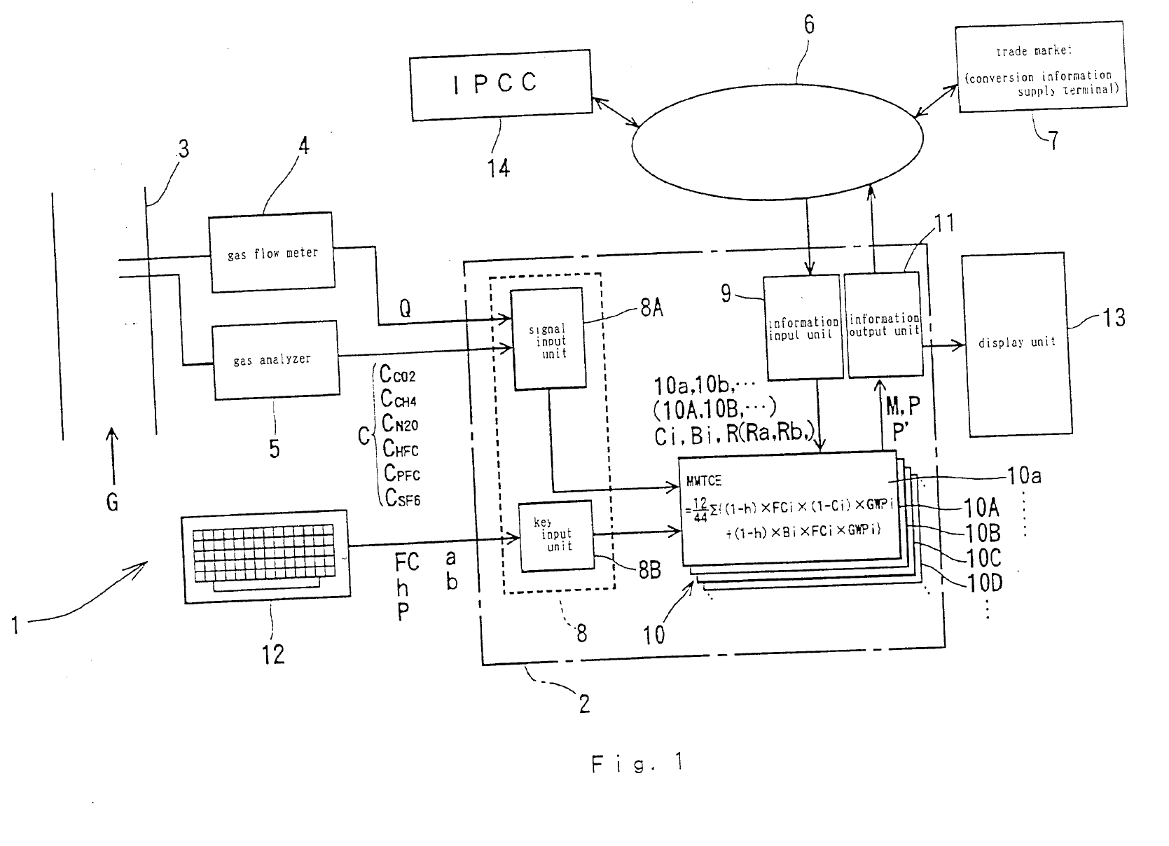

FIG. 1 is a diagram showing an example of a greenhouse effect gas emissions rights trading or converting system 1 of the present invention.

In FIG. 1, reference numeral 2 is a greenhouse effect gas emission index converter (operation processing unit in this example) installed in a user factory that is emitting greenhouse effect gases. Reference numeral 3 is an process effluent of pollutant emission gas such as a factory flue. Reference numeral 4 is a gas flow meter installed in the process effluent 3. Reference numeral 5 is a gas analyzer for analyzing the concentration of gas flowing in the emission passage 3. Reference numeral 6 is the Internet™ as an example of a global computer network, and reference numeral 7 is an example of a trade market unit connected to each greenhouse effect gas emission index converter 2 through the Internet™ 6, which also functions as a conversion information supply terminal 7 in this example as mentioned below.

The greenhouse effect gas emission index converter 2 includes a data input unit 8 for entering various data necessary for converting into a predetermined emission index of greenhouse effect gas for the user, an information input unit 9 for entering conversion information or the like for converting into the emission index of greenhouse effect gases through the Internet™ 6, an operation processing unit 10 such as a computer based control unit for calculating a real time usage rate by using the various data obtained through the data input unit 8, and the conversion information obtained through the information input unit 9, and information output unit 11 for sending out the actual calculated emission index of greenhouse effect gases for the user obtained in the operation processing unit 10 through the Internet™ 6 to the trade market unit 7.

Reference numeral 12 is a keyboard of the greenhouse effect gas emission index converter 2 for entering the purchase weight FC of greenhouse effect gas, rate h of unused gas, type P of process, decomposition factor a of abatement equipment of the plant, decomposition factor b of abatement equipment of each decomposition system and others. Reference numeral 13 is a display unit of the greenhouse effect gas emission index converter 2. Reference numeral 14 is a monitoring organization for organizing the emission amount of greenhouse effect gases of the user such as the IPCC.

The above-mentioned pollutant process effluent 3 is the passing route of the entire gas emitted from, for example, a semiconductor manufacturing process. When gases emitted from plant facilities are released through several process effluent 3, a pair of gas flow meter 4 and gas analyzer 5 must be installed in each process effluent 3.

The gas flow meter 4 is available in various conventional types, and for example, an ultrasonic type, Doppler type, and Karman's vortex may be used.

The gas analyzer 5 is capable of measuring the concentration of greenhouse effect gas contained in the emission gas G flowing in the process effluent 3 in real time, and preferably a FTIR (Fourier Transform Infrared Ray) gas analyzer is used. However, for batch measurement, a gas chromatography or a mass analyzer may also be used. Components to be measured are, for example, CO₂, CH₄, N₂O, HFC, PFC, and SF₆, and in the following explanation, the concentrations of the individual greenhouse effect gases are expressed as CCO₂, CCH₄, CN₂O, CHFC, CPFC, and CSF₆, respectively.

The types of greenhouse effect gases or other pollutants are not limited in the present invention. Hence, the types of the gas analyzer 5 are not limited. That is, any pollutant or greenhouse effect gas may be measured, and the concentration of such pollutants and greenhouse effect gases may be measured by any gas analyzer 5. Greenhouse effect gases are used as one preferred example of the present invention.

The above-mentioned data input unit 8 comprises a signal input unit 8A for entering measured values by the gas flow meter 4 and FTIR 5, for example, and a key input unit 8B for entering various data from the keyboard 12. The above-mentioned operation processing unit 10 has various conversion formulas 10a, 10b for calculating the emission index of greenhouse effect gases by using various data CCO₂, FC, h, P, a, d, from the input data unit 8.

The above-mentioned conversion formulas 10a, 10b (conversion information) are conversion formulas or algorithms designated by a monitoring organization for organizing the emission of greenhouse effect gases such as the IPCC, and are stored in a digital format to be executed by the operation processing unit 10, for example, in the form of conversion programs 10A, 10B. In the following explanation of this example, the conversion programs 10A, 10B to be calculated on the basis of the conversion formulas 10a, 10b of emission index of greenhouse effect gases are presented as an example of conversion information, but the conversion information of the present invention is not limited to just conversion programs 10A, 10B. For example, an operation matrix of the conversion formulas 10a of emission index of greenhouse effect gases expressed in a matrix calculation can be stored as conversion information, and various further modifications are possible.

At the side of the above-mentioned conversion information supply terminal 7, for example, communicating with the IPCC 14 through the Internet™ 6, it is possible to browse the latest conversion formulas 10a, 10b posted on line for calculating the emission index of greenhouse effect gases determined by the IPCC 14, and the values of coefficients used in these conversion formulas 10a, 10b. Conversion programs 10A, 10B, are compiled for executing a calculation of emission index of greenhouse effect gases on the basis of the conversion formulas 10a, 10b revised by the IPCC 14, by the operation processing unit 10, and these conversion programs 10A, 10B, are distributed as conversion information to each greenhouse effect gas emission index converter 2 through the Internet™ 6.

Therefore, when each greenhouse effect gas emission index converter 2 executes a specified program among the conversion programs 10A, 10B received from the conversion information supply terminal 7, the emission index of greenhouse effect gases (for example, carbon equivalent) M using a common conversion formula can be calculated, and it can be displayed in the display unit 13. Further, each greenhouse effect gas emission index converter 2 issues the emission index M of greenhouse effect gases through the information output unit 11 so that a greenhouse effect gas emissions rights can be traded with other greenhouse effect gas emission index converters. At that time, a trade market unit 7 may be created to act as a clearinghouse for such trade.

In the configuration of this example, the conversion formulas 10a for calculating the emission index of greenhouse effect gases can be changed in batch by an instruction from the conversion information supply terminal 7, or by using an adjusted conversion formula, so that the emission index of greenhouse effect gases can be obtained very easily. That is, the conversion formula of emission index of greenhouse effect gases determined by the IPCC 14 or the like can be easily used in order to monitor the emission amount of greenhouse effect gases or to trade an emissions rights for greenhouse effect gases between users.

In any trade of an emissions rights of greenhouse effect gases, if agreed between the trading partners, the emissions rights may be traded by using other conversion formulas than the conversion formula of emission index of greenhouse effect gases specified by the IPCC 14 or the like. Distribution of conversion programs 10A, 10B, or designation of conversion formula used in calculation of emission index of greenhouse effect gases is not always commanded from the trade market such as conversion information supply terminal 7, but may also be offered from others such as IPCC 14, JEITA (Japan Electronics and Information Technology Industries Association), government office (Ministry of Economy and Industry) etc.

On the other hand, as the conversion formula for calculating the emission index of greenhouse effect gases, for example, the following conversion formulas are proposed at the present. That is, a conversion formula for calculating an approximate value of the total emission amount of greenhouse effect gases (emission index of greenhouse effect gas) called Tier 1 in IPCC 14 is expressed in formula (2) below in terms of carbon equivalent (MMTCE).

$$MMTCE = 12 / 44 {\sum }_{i} \{ ( 1 - h ) \times FCi \times ( 1 - Ci ) \times GWPi + ( 1 - h ) \times Bi \times FCi \times GWPCF4 \} \qquad ( 2 )$$

where FCi is i-th purchase gas weight, GWPi is 100-year value of global warming index GWP of i-th gas, h is the rate of residual gas in returned cylinders, Ci is the default value of gas consumption rate, Bi is the default value of generation rate of CF₄ gas as a by product, and GWPCF₄ is 100-year value of global warming index GWP of CF₄ gas.

The 100-year value of global warming index GWP is one form of conversion information determined by the IPCC 14, and at the present it is determined as shown in Table 1. If it is necessary to revise the value of the global warming index GWP, the latest value could be distributed from the conversion information supply terminal 7, so that it can be always kept current and universally available for all users and the trade market unit.

TABLE 1

| Type of Gas | Value of GWP | Life (year) |
|---|---|---|
| CF₄ | 6500 | 50000 |
| C₂F₆ | 9200 | 10000 |
| C₃F₈ | 7000 | 2600 |
| C₄F₈ | 8700 | 3200 |
| C₅F₈ | 90 | 0.98 |
| CHF₃ | 11700 | 264 |
| SF₆ | 23900 | 3200 |
| NF₃ | 8000 | 700 |
| CO₂ | 1 | 50-200 |

Similarly, the conversion formula for calculating the approximate value of the total emission amount of greenhouse effect gases (emission index of greenhouse effect gases) called “Tier 2B”, “Tier 2C” in IPCC 14 is expressed in formula (3) below in terms of carbon equivalent (MMTCE).

$$MMTCE = 12 / 44 {\sum }_{i} \{ ( 1 - h ) \times FCi \times ( 1 - Ci ) \times ( 1 - ai di ) \times GWPi + ( 1 - h ) \times Bi \times FCi \times ( 1 - {a}_{i} {d}_{{CF}_{4}} ) {GWP}_{{CF}_{4}} \} \qquad ( 3 )$$

where aᵢ is the decomposition factor of abatement equipment of the plant of i-th gas, dᵢ is the decomposition factor of the abatement equipment, dCF₄ is the decomposition factor of CF₄ of the abatement equipment, and others are same as in formula (2).

In the case of Tier 2C, default values Bi, Ci are constant regardless of the type of the semiconductor manufacturing plant, and in the case of Tier 2B, default values Bi and Ci are different whether the semiconductor plant is of dry etching or CVD.

The conversion formula for calculating the approximate value of the total emission amount of greenhouse effect gases (emission index of greenhouse effect gases) called “Tier 2A” is expressed in formula (4) below in terms of carbon equivalent (MMTCE).

$$MMTCE = 12 / 44 {\sum }_{i } \{ ( 1 - h ) {\sum }_{P} [ FCi , p \times ( 1 - Ci , p ) \times ( 1 - {a}_{ip} {d}_{ij} ) \times GWPi + Bi , p \times FCi , p \times ( 1 - {a}_{ip} {d}_{{CF}_{4} j} ) {GWP}_{{CF}_{4}} ] \} \qquad ( 4 )$$

where p is the number of processes or types of process, FCi, p is i-th purchase gas weight in process p, Ci, p is the default value of consumption rate of i-th gas in process p, aᵢₚ is the decomposition factor of abatement equipment of the enterprise or plant of i-th gas in process p, dᵢⱼ is the decomposition factor of each decontamination system, Bi,p is the generation rate of CF₄ gas produced in process p, dCF₄ⱼ is the decomposition factor of CF₄ of decontamination apparatus, and others are same as in formulas (2) and (3).

The conversion formulas shown in the above-mentioned formulas (2) to (4) are mainly calculated by using the data (FC, h, P, a, b) entered through the above-mentioned keyboard 12, but the gas consumption rate Ci and CF₄ gas generation rate Bi in formulas (2) and (3) are constant values (default values) used in the conversion formulas 10a, 10b entered through the above-mentioned information input unit 9. Therefore, these constants Ci, Bi are adjusted properly by the judgment of the IPCC 14, and it is possible to react promptly by using the greenhouse effect gas emission index converting system 1 of the present invention to integrate any change in such constants. Of course, these constants Ci, Bi and conversion formulas 10a, 10b may be also entered through the keyboard 12. On the other hand, the gas consumption rate Ci, p, and CF₄ gas production rate Bi, p in formula (4) are determined from the measured values by the gas analyzer 5.

In the greenhouse effect gas emission index converting system 1 of the example, since the gas flow meter 4 and gas analyzer 5 are provided in the process effluent 3, by multiplying the measured values Q, C obtained from these instruments 4, 5, it is also possible to determine the emission amount Q₁ of the greenhouse effect gases CO₂, CH₄, N₂O, HFC, PFC, and SF₆ (QCO₂, QCH₄, QN₂O, QHFC, QPFC, and OSF₆). Formula (5) shows this relationship.

Qi=Ci×Q (5)

where i denotes the type of greenhouse effect gases CO₂, CH₄, N₂O, HFC, PFC, and SF₆.

When the emission amount of greenhouse effect gases CO₂, CH₄, N₂O, HFC, PFC, and SF₆ in the above-mentioned formula (5) is multiplied by the global warming index GWP, and the sum is calculated, as shown in formula (6), the momentary value Qₜₒₜₐₗ of the total emission of the greenhouse effect gases converted to CO₂ is determined.

Qₜₒₜₐₗ=Σ(Ci×Q×GWP₁) (6)

where i denotes the type of greenhouse effect gases CO₂, CH₄, N₂O, HFC, PFC, and SF₆.

The operation processing unit 2 integrates the momentary value Qₜₒₜₐₗ of emission for a specified time according to formula (7), and the emission index of greenhouse effect gas (carbon equivalent) MMTCE is determined.

MMTCE=∫Qₜₒₜₐₗ (7)

That is, the greenhouse effect gas emission index converting system 1 comprises the gas flow meter 4, gas analyzer 5, and signal input unit 8A (data input unit 8) for entering measuring signals C, Q from them so that the emission index of greenhouse effect gases is more accurate and a fair index that can be utilized for trading purposes and monitoring is obtained. Calculation, as shown in the above-mentioned formulas (5) to (7), can be executed with the conversion programs initially stored, for example, in the-operation processing unit 2, but may be also executed by the conversion programs 10A, 10B, distributed from the above-mentioned conversion information supply terminal 7.

When calculating the emission index of greenhouse effect gases by a calculation as shown in the above-mentioned formulas (5) to (7), it is not necessary to enter the numerical data by using the keyboard 12, and not only the complicated input work can be omitted, but also appropriate countermeasures may be taken by discovering any decline of efficiency of the abatement equipment or an occurrence of abnormality of the plant processes in an earlier stage. In particular, the FTIR presented as an example of gas analyzer 5 is an analyzer of multiple components, and components to be measured can be set freely. Therefore, a new gas designated as greenhouse effect gas by the IPCC 14 may be entered as part of the conversion information, and the emission index of greenhouse effect gases can be converted by using this new information.

In the conversion formulas presented above, an example of expressing the emission index M of greenhouse effect gases in terms of carbon equivalent (MMTCE) is presented and the degree of greenhouse effect is expressed adequately by using a one-dimensional numerical value. However, the present invention is not intended to be limited to such an example. That is, the emission index M of greenhouse effect gases may be any index expressing the emission index of each greenhouse effect gas.

It is a feature of the greenhouse effect gas emission index converting system 1 of the present invention that the emissions rights which can be traded or sold of greenhouse effect gases is calculated on the basis of a single common emission index by each greenhouse effect gas emission index converter 2 by incorporating the conversion formulas (conversion information) for calculating the emission index M of greenhouse effect gas through the network 6 as shown in respective formulas (2) to (7).

As in this example, when each greenhouse effect gas emission index converter 2 stores plural conversion programs 10A, 10B, if the enterprises mutually agree, it is possible to trade the emissions rights by using the emission index of greenhouse effect gas calculated according to other conversion formula different from the conversion formula determined by the general trade market 7 or IPCC 14.

In addition, by using the greenhouse effect gas emission index converting system 1 of the invention, it is also possible to determine the trade information R per unit volume of carbon dioxide (that is, conversion rate Ra or exchange rate Rb for converting the emission index into amount of money for trade) used in the greenhouse effect gas emissions rights trade in the trade market 7 or the IPCC 14. That is, as shown in formula (8) below, by multiplying the emission index M of greenhouse effect gas and the conversion rate Ra, the emission expense P of greenhouse effect gas (that is, the trade amount P′) can be calculated.

P=M×R (8)

That is, the conversion result information can be determined by an approximate calculation with the operation processing unit 10 using the above-mentioned conversion formula issued through the Internet™ 6 and can be expressed not only by the emission index M of greenhouse effect gas (generally carbon equivalent MMTCE), but also by the emission expense P, trade amount P′, or total amount of greenhouse effect gases or total amount of CO₂.

When trading between nations differing in monetary currency, the monetary exchange rate Rb is taken into consideration as the above-mentioned trade information R, and by calculating the trade amount P′, the emissions rights of greenhouse effect gas can be traded between different nations.

Incidentally, when the information output unit 11 issues the emission index M of greenhouse effect gas to the trade market unit 7 through the Internet ™ 6, the trade market unit 7 can check how much greenhouse effect gases are emitted in each factory. That is, while the trade market unit 7 is adjusting the emission of greenhouse effect gases within a specified range in the entire district, an enterprise emitting an excessive amount of greenhouse gases can purchase the emissions rights of greenhouse effect gases from other enterprises emitting a smaller amount of greenhouse effect gases than their quota.

The output of the emission index M of greenhouse effect gases from each enterprise is not limited to presentations to the trade market unit 7 alone. That is, the emission index M of greenhouse effect gas can be also issued to a government regulatory office (Ministry of Economy and Industry), JEITA, or other association.

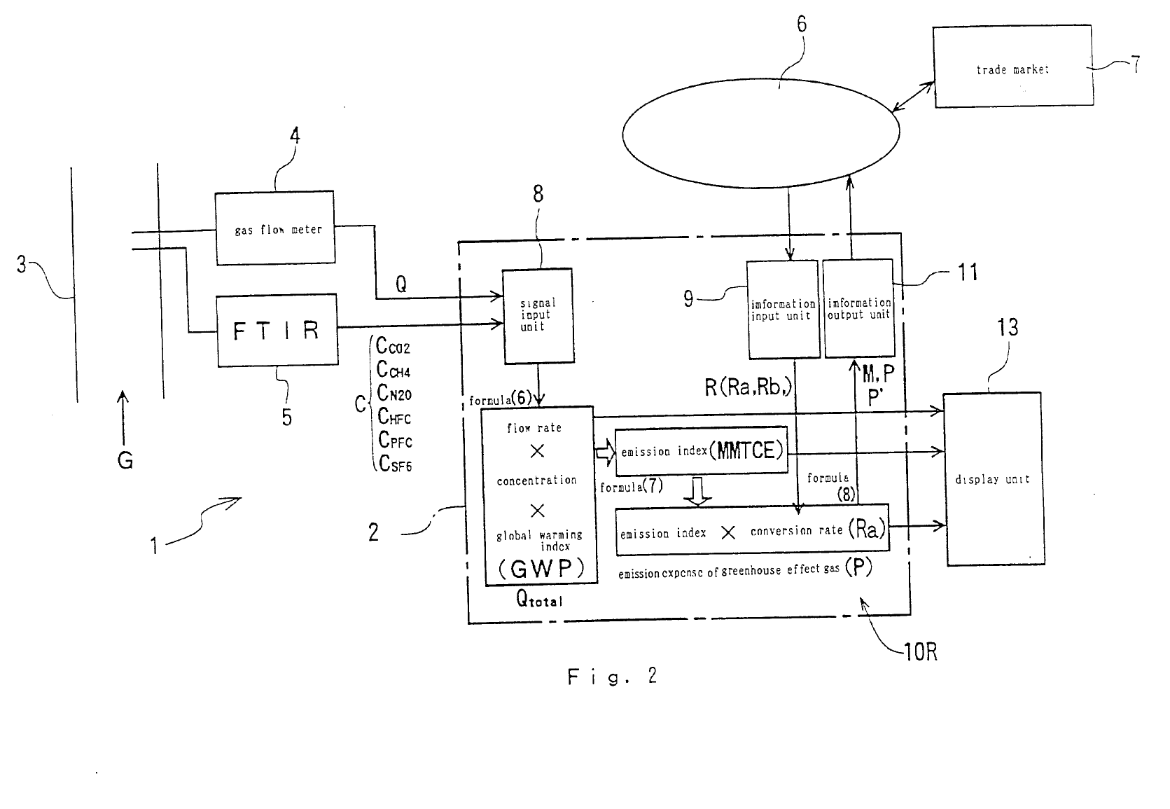

FIG. 2 is a diagram showing a modified example of the above-mentioned greenhouse effect gas emission index converting system 1, and the same reference numerals as in FIG. 1 represent corresponding parts. The greenhouse effect gas emission index converting system 1 of this example is to determine the emission index of greenhouse effect gas from the measured concentration C and flow rate Q of each gas.

Therefore, the greenhouse effect gas emission index converter 2 is an operation processing unit connected to the gas flow meter 4 and gas analyzer 5, and this operation processing unit 2 comprises a signal input unit, as the data input unit 8, for entering the flow rate Q measured by the gas flow meter 4, and the concentration C of each gas measured by the gas analyzer 5, and the above-mentioned information input unit 9 can enter the trade information R (for example, conversion rate Ra and exchange rate Rb), and the emission index M of greenhouse effect gas and emission expense P (including the trade amount P′ in consideration of exchange rage Rb) are issued through the information output unit 11.

Therefore, in the operation processing unit 2 (as shown in FIG. 2), an operation program 10R for processing the operation of the above-mentioned formulas (6) to (8) described above is stored, the operation processing unit 2 executes this conversion program 10R, and thereby the emission index M of greenhouse effect gases and emission expense P are calculated and are issued to the display unit 13 or information output unit 11.

Since the emission amount of greenhouse effect gases is determined by calculating from the measured values of the gas flow meter 4 and gas analyzer 5, not only an accurate emission amount of greenhouse effect gases emitted through the process effluent 3 can be measured, but also the conversion program 10R is operated to convert into the emission expense P (or trade amount P′) of the greenhouse effect gases in real time, so that the emission right of greenhouse effect gases can be traded easily on a regulated market with confidence in its value.

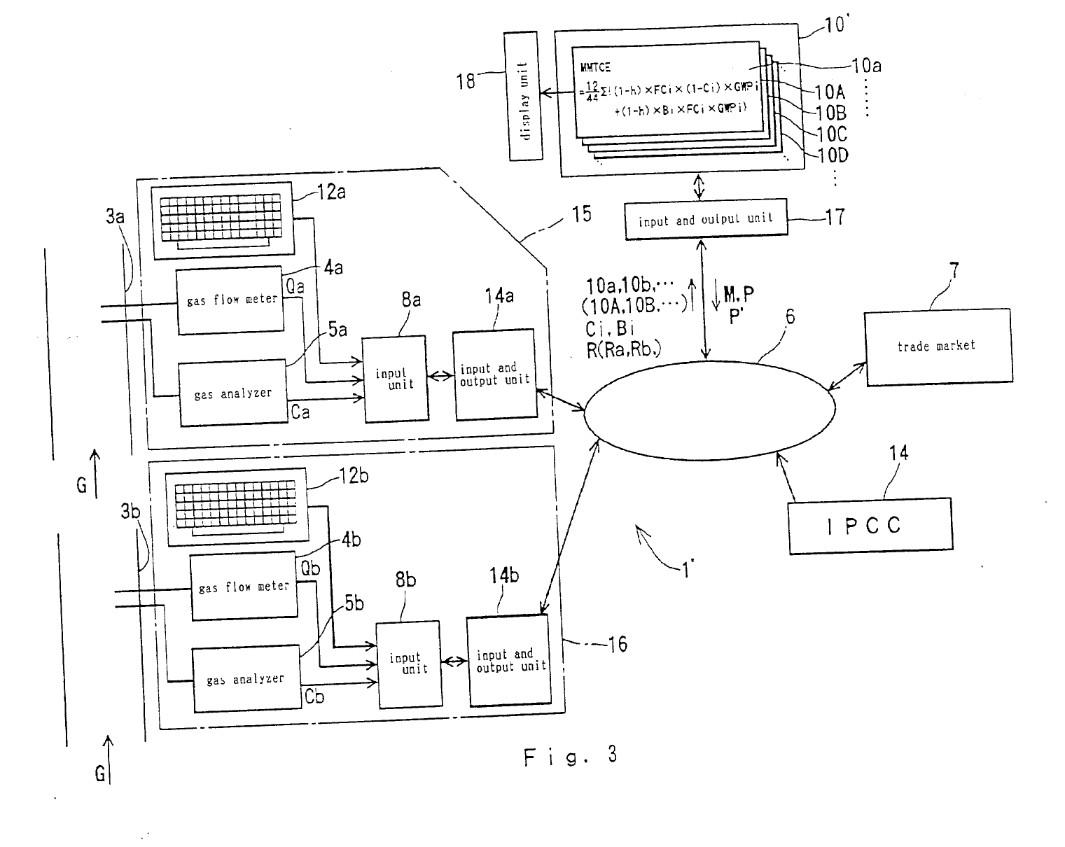

FIG. 3 shows another example of the greenhouse effect gas emission index converting system of the invention. In FIG. 3, the same reference numerals as in FIG. 1 are used or are corresponding parts and a detailed description is omitted.

In FIG. 3, reference numeral 10′ is an operation processing unit installed in each enterprise, 3a, 3b are process effluent controlled by the operation processing unit 10′, reference numerals 4a, 4b are gas flow meters installed in the process effluent 3a, 3b, reference numerals 5a, 5b are gas analyzers, reference numerals 8a, 8b are input units for entering measured values Qa, Ca, Qb, Cb by the measuring instruments 4a, 4b, 5a, 5b, reference numerals 12a, 12b are keyboards, and reference numerals 14a, 14b are input and output units for connecting the signal input units 8a, 8b to the operation processing unit 2 through the Internet™ 6. Reference numerals 15, 16 are measuring units installed in the process effluent 3a, 3b.

Reference numeral 17 is an input and output unit (information input unit and information output unit) on the operation processing unit 10′ side, and reference numeral 18 is a display unit for displaying the emission amount of the greenhouse effect gas calculated by the operation processing unit 10′.

In the operation processing unit 10′, the measuring units 15, 16 are attached to plural process effluent 3a, 3b installed in the enterprises, and are connected to the operation processing unit 10′ through the network 6, so that a greenhouse effect gas emission right converting system 1′ can be composed.

Therefore, by properly installing the measuring units 15, 16, according to the number of process effluent 3a, 3b, each enterprise can easily check the emission index M of all greenhouse effect gases being emitted in real time. That is, the amount of gas emission can be accurately known as compared with the assigned emission framework, and an emissions rights can be purchased from another user enterprise having a sufficient allowance left, or an extra portion of the quota can be sold to a user enterprise in need. The measuring units 15, 16, are simple in structure, and the manufacturing cost can be significantly lowered.

As in this example, the operation processing unit 10′ can be formed by using a desired conversion function formed on the global communication network 6, and the configuration is not particularly limited. In this example, the server is installed in each user enterprise, and the operation processing unit 10′ is formed by using this server, but it may be also designed to be executed by another computer on the network 6. For example, when the trade market unit 7 is also designed to actively monitor the measured values by the measuring units 15, 16, it is possible to monitor if each enterprise is operating adequately from the viewpoint of the global environment quotas.

Each operation processing unit 10′ processes by converting into the emission index of greenhouse effect gas by using conversion formulas 10a, 10b and constants (conversion information) conforming to the standard determined by the organization of the IPCC 14, and the emission guidance of greenhouse effect gas can be calculated by a single conversion formula or formulas common to all so that a fair determination of a user emissions rights can be traded.

In addition, the emission guidance of greenhouse effect gases can be converted in a hierarchical structure. That is, summing up the total emission index calculated in each enterprise user in each district, the total amount of greenhouse effect gas emitted in the district unit can be calculated, or the total emission index summed up in each district unit can be calculated on the national basis, and the total amount of greenhouse effect gases emitted in each nation can be compared. Moreover, the emissions rights of greenhouse effect gases can be traded not only between enterprises, but also between nations, or communities.

In this example, the Internet™ 6 is used as a general example of the global computer network 6, but alternative networks can be used, for example, by using the intranet or a limited communication network instead of the Internet™, the security may be enhanced.

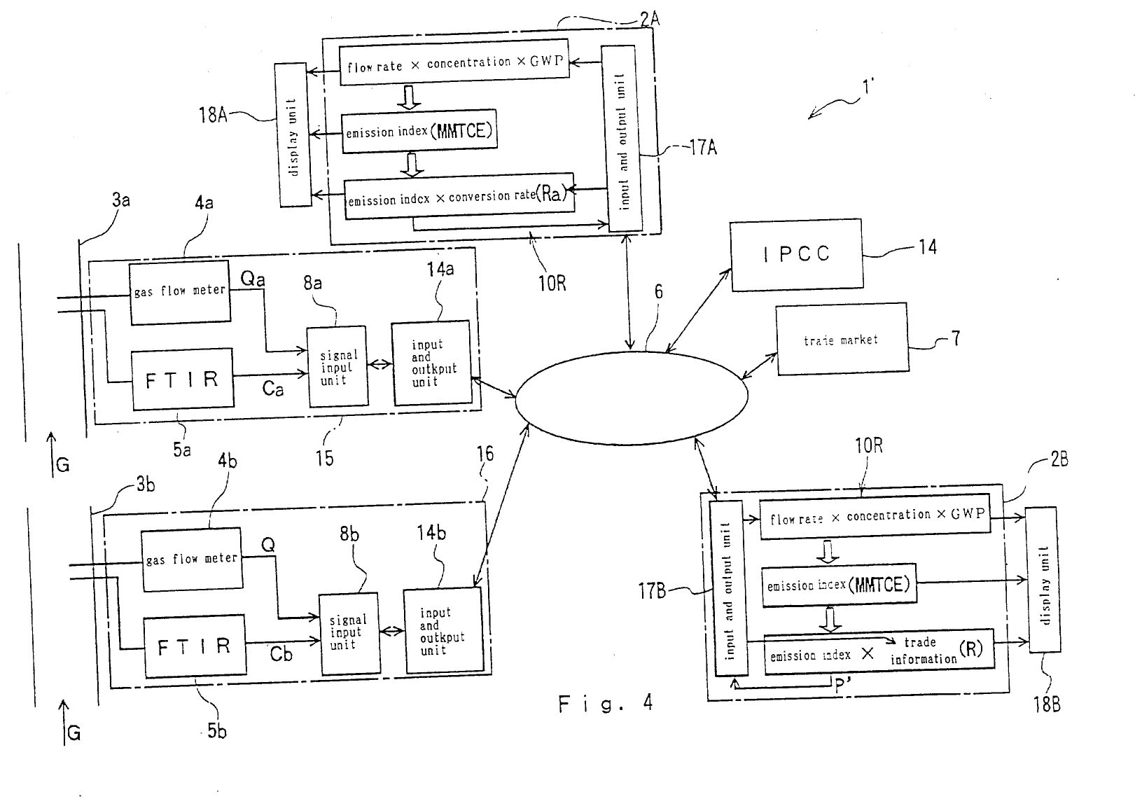

FIG. 4 is a diagram showing a further modified example of a greenhouse effect gas emission index converting system 1′. In this example, the same reference numerals as in FIG. 3 are the same for corresponding parts. Reference numerals 2A, 2B, are operation processing units installed in user enterprises. In this example, measuring units 15, 16, are installed in process effluent 3a, 3b, controlled by the operation processing unit 2A. Reference numerals 17A, 17B, are input and output units provided in the operation processing units 2A, 2B, and 18A, 18B, are display units.

As all operation processing units 2A, 2B, execute the same conversion program 10R, measured values measured by all measuring units 15, 16, to be managed are taken in through the network 6 in calculation formulas shown in the above-mentioned formulas (6) to (8), so that the emission index M of greenhouse effect gas and emission expense P are determined.

In FIG. 4, keyboards 12a, 12b (see FIG. 3) are excluded from the measuring units 15, 16, and the system structure is further simplified and the manufacturing cost is saved. Incidentally, the IPCC or other environmental management office may properly monitor the measuring units 15, 16, through the network 6 to check if the enterprises are conforming to the specified emission framework or not, and a requirement to purchase an emissions rights may be advised to the user enterprise running short of their emissions rights.

Besides hierarchical calculation of emission amount of greenhouse effect gases, various modifications can be executed as explained in FIG. 3.

By using the greenhouse effect gas emission index converting system of the invention as described herein, the emission amount of greenhouse effect gas can be converted into a common and single transaction index, and can be converted into the emission index of greenhouse effect gas using the latest conversion formula and conversion coefficient.

Moreover, the total amount of the emitted greenhouse effect gases can be determined accurately from the measured values, and the emissions rights can be directly converted and issued as the amount of money of trade, so that an adequate emissions rights can be traded promptly.

Those skilled in the art will appreciate that various adaptations and modifications of the just described preferred embodiments can be configured without department from the scope and spirit of the invention. Therefore, it is to be understood that, within the scope of the appended claims, the invention may be practiced other than as specifically described herein.

What is claimed is:

1. A system for providing an exchange market for trading assigned quotas of permissible pollutants comprising:
a standard source for providing algorithm data to establish a relationship between pollutant emissions and an assigned quota to enable a usage rate relative to a predetermined index value to be determined;
a monitoring unit for measuring the actual pollutant emissions of a user having an assigned quota and outputting a corresponding emission signal;
a control unit for storing the algorithm data and emission signal and calculating a real time usage rate;
a trade market unit for listing real time surplus usage rates relative to the predetermined index rate that are below their assigned quotas and available for purchase; and
means for connecting the control unit to the trade market unit to determine a matching of a listed surplus rate with the real time usage rate when the usage rate is over the assigned quota.

2. The system of claim 1 wherein the means for connecting further includes listing an available surplus rate on the trade market unit when the usage rate is below the assigned quota.

3. The system of claim 1 wherein the control unit can poll the standard source to download the current algorithm data applicable to the trade market unit.

4. The system of claim 1 wherein the trade market unit further lists the monetary values of surplus usage rates that can be purchased.

5. The system of claim 1 wherein the monitoring unit can measure more than one pollutant.

6. The system of claim 1 wherein the monitoring unit measures consumption of a gas and the emissions from the act of consumption.

7. The system of claim 1 wherein the means for connecting includes a global computer network.

8. A system for monitoring pollutants relative to a standardized quota system, comprising:
a standardized source of data to enable a determination of a relationship between pollutant emission of a user and an assigned quota to the user;
a monitoring unit for measuring the pollutant emissions of the user having the assigned quota and outputting a corresponding emission signal;
a control unit connected to the monitoring unit and storing the standardized source of data and the emission signal for calculating the actual pollutant emission rate relative to the assigned quota;
means for entering the standardized source of data in the control unit; and
means for outputting the actual pollutant emission rate relative to the assigned quota.

9. The system of claim 8 wherein the means for outputting includes interconnecting the control unit with a global computer network.

10. The system of claim 9 wherein the means for entering includes interconnecting the control unit with a global computer network to download the standardized source of data.

11. A greenhouse effect gas emission index converting system comprising:
a data input unit for entering data for calculating an emission index of greenhouse effect gases;
an information input unit for incorporating the conversion information for calculating the emission index of greenhouse effect gases by using various data;
an operation processing unit for calculating the emission index of greenhouse effect gases by calculating the various data according to the conversion information; and
an information output unit for issuing the calculated emission index.

12. The greenhouse effect gas emission index converting system of claim 11 wherein a part of the data includes measured at least one concentration and/or flow rate data of at least one greenhouse effect gases, and the emission index is calculated by integration of their multiplied products.

13. The greenhouse effect gas emission index converting system of claim 11 wherein at least one of incorporation of data in the data input unit, incorporation of conversion information in the information input unit, or output of emission index in the information output unit is executed through a global computer network.

14. The greenhouse effect gas emission index converting system of claim 11 wherein the conversion information involves a conversion index for calculating the emission index of greenhouse effect gases determined by a monitoring organization for organizing the emission amount of greenhouse effect gas and/or the constants used in such conversion formula.

15. The greenhouse effect gas emission index converting system of claim 11 wherein the conversion information has a conversion rate for calculating the emission expense of greenhouse effect gas by multiplying with the emission index of greenhouse effect gas, and operation processing unit has a market reference function of entering the conversion rate, exchange rate and other trade information from a trade market unit for exchanging a greenhouse effect gas quota through the information input unit.

16. The greenhouse effect gas emission index converting system according to claim 11 wherein the above-mentioned, operation processing unit has a market disclosure function of outputting a user trade right amount by multiplying trade information such as conversion rate and exchange rate with the emission index of the greenhouse effect gases to a trade market unit of greenhouse effect gases through the information output unit.
